(19) United States
(12) Patent Application Publication
(10) Pub. No.: US 2012/0168007 A1
(43) Pub. Date: Jul. 5, 2012

(54) High pressure pneumatic or hydraulic actuated flow indicating switch/check valve combination

(76) Inventor: Scott Fredric Wonders, Port Arthur, TX (US)

(21) Appl. No.: 12/930,126

(22) Filed: Dec. 29, 2010

(51) Int. Cl. F17D 3/00

(52) U.S. Cl. 137/551

(57) ABSTRACT

The High Pressure Flow Indicating Switch devise and method is used to monitor the flow of a gaseous, liquid or finely divided solid material through pipes, tubing or equipment. This devise is an improvement over technology available at the present time due to its accuracy over an extremely wide range of pressure/flow, simplicity of operation and low cost to manufacture. This High Pressure Flow Indicating Switch is primarily comprised of a pressure confining cylinder housing through which a magnetic field can pass with minimal distortion, a piston containing a magnetic source which emits a magnetic field and a reed/proximity switch mounted to the exterior of the pressure cylinder housing which monitors the position of the magnetic field. As a liquid or gas passes through the cylinder housing, the piston with its magnetic field is displaced and moves in the direction of the material flow. Electrical contacts within the reed/proximity switch are activated by the subsequent magnetic field alignment thus indicating a “Flow” or “No Flow” condition.

This application claims priority from provisional application No. 61/4000,862 filed on Aug. 4, 2010 which has the confirmation number of 8615

### SUMMARY

Most high pressure (pressures greater than 1500 psi) flow indicating switches, which are available at the present time, determine the flow of a gaseous or liquid material flowing through a pipe or tube using the following method.

A restricting orifice is placed in the pipe or tube and as the gaseous or liquid material passes through this orifice, the pressure drop (or vacuum) on the immediate downstream side of this orifice is measured. This pressure drop (or vacuum) is then used to determine the velocity or volume/quantity of the material which is flowing through the pipe or tube.

The technical aspects of design and manufacture of this type of system are very complicated and expensive to produce. Also, this method does not retain flow accuracy over a wide range of pressures and is susceptible to failure caused by contaminants in the flow stream such as moisture, dirt or grit.

The high pressure flow indicating switch device and method presented in this patent application is an alternative to the standard design of flow indicating switches which are available at the present time and discussed briefly in the above three paragraphs.

The proposed flow indicator switch is used to determine if the flow of a gaseous or liquid material through a pipe, tube or equipment has been stopped at any point upstream or downstream of the flow indicating switch. Most flow indicating devices presently available will be adversely affected by the resulting pressure buildup caused by the interruption of flow of a gaseous or liquid material downstream of the devise.

Since the flow indicating switch proposed in this patent application relies on the flow of a material and not pressure, the slowing or stoppage of the material flow downstream of the high pressure flow indicating switch and subsequent pressure buildup will have no adverse reactions or effect on its operation. The high pressure flow indicating switch has a very simple operating principle. High pressure gaseous or liquid material flowing through a pressure housing displaces (moves) a spring loaded poppet piston which contains a magnetic source. The position of this magnetic source is sensed by a reed/proximity switch which is mounted on the exterior of the pressure housing. The alignment of the magnetic source and the reed/proximity switch electrical will the either open or close the contacts. The opening or closing of these contacts will “make” or “break” the electrical circuit of the reed/proximity switch. The making or breaking of this electrical circuit will indicate whether a material is passing through the flow indicating switch. As flow of the material through the flow indicating switch housing slows or stops completely, the poppet piston return spring pressure will push the poppet piston back into its normally closed position thus “making” or “breaking” the electrical circuit that material has stopped passing through the flow indicating switch.

The quantity of material flow through the flow indicator switch required to displace the poppet and activate the reed/proximity switch can be adjusted by increasing or decreasing the clearance between the poppet piston nose and the orifice into which the poppet nose rests or changing the poppet piston return spring pressure.

The flow indicating switch can be converted to a check valve with the addition of an o-ring to the base of the poppet piston nose. The flow indicating characteristics and operation of the switch will not change by this addition however now the high pressure flow indicating switch will now have the secondary function of acting as a flow check valve which will prevent the material flow from reversing and moving upstream in the event that the downstream pressure becomes greater than that of the upstream pressure.

The high pressure flow indicating switch can also be converted to a pressure holding regulator designed to hold a minimal predetermined residual pressure upstream of the switch by simply adding a check ball/spring assembly to the interior of the poppet piston.

Some of the benefits of this new design flow indicator switch are 1—reliability, 2—accuracy through a wide pressure/volume range, 3—manufacturing simplicity, 4—inexpensive to produce, 5—functionality remains unaffected by pressure buildup created when downstream flow is blocked and 6—not as susceptible to failure due to dirt, grit or corrosion.

This design of high pressure flow indicating switch can be used to monitor the flow of any pneumatic, hydraulic or finely divided solid materials through a pipe, tube or housing. However, the primary purpose of its design is to make possible the construction of an efficient, reliable and low cost auto-cascade system used to recharge SCBA and SCUBA cylinders used by Fire Fighters and SCUBA divers.

To accomplish the construction of the auto-cascade system mentioned in the above paragraph, the high pressure flow indicating switch will be used to determine whether the flow of compressed breathing air is present through the various parts of the auto-cascade system and then accurately activate the discharge sequence of the various stages of an electric, electric over pneumatic or electric over hydraulic operated cascade storage system. The output/discharge of this auto-cascade system will be used to recharge self contained breathing apparatus (SCBA) or self contained under water breathing apparatus (SCUBA) cylinder(s). (See FIG. 7.)

### BRIEF DESCRIPTION OF DRAWINGS

FIG. 1—Sectional view of the basic flow indicating switch design.

FIG. 2—Two states of a flow indicating switch in use. Flow and no flow.

FIG. 3—Variation of FIG. 1 which has a higher accuracy at all flows.

FIG. 4—Variation of FIG. 3 which uses a secondary poppet piston which is enclosed in the primary poppet piston.

FIG. 5—Variation of FIG. 1 with poppet piston to cylinder o-ring seal.

FIG. 6—Variation of FIG. 4 which is used to regulate/hold back pressure upstream of the flow indicating switch.

FIG. 7—Schematic of a self sequencing automatic cascade system used for recharging SCBA breathing air cylinders which uses the high pressure flow indicating switch shown in FIG. 1 as the key operating component.

### DETAILED DESCRIPTION

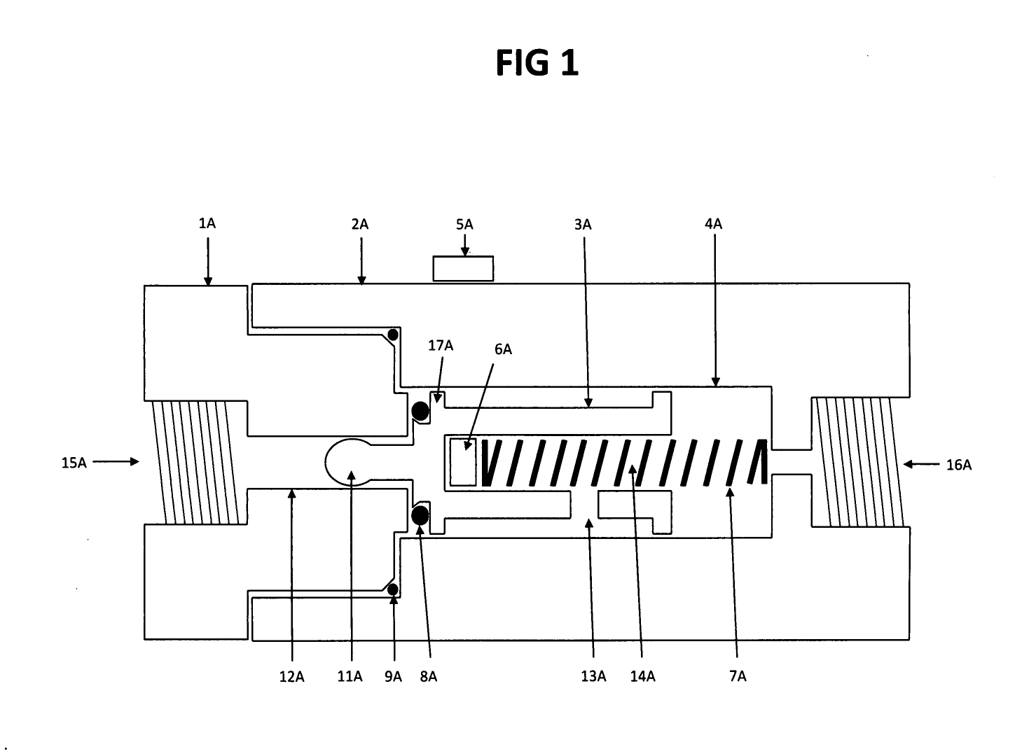

### FIG. 1

The 9A-gasket or o-ring seal between the 1A-pressure cylinder housing cap and 2A-pressure cylinder housing ensures a tight flow and pressure seal so that material flowing into and through the high pressure flow switch cannot leak outside of the flow switch.

As a compressed gaseous or liquid material enters the 15A-inlet of the 1A-cylinder housing cap it will come into contact with the 11A-poppet piston nose. As the flow through the clearance between the 11A-poppet piston nose and 12A-poppet nose receiving orifice exceeds a predetermined amount, which is determined by the clearance between the 11A-poppet piston nose and 12A-poppet nose receiving orifice and/or 14A-poppet return spring pressure, the 11A-poppet nose and 3A-poppet will overcome the 7A-poppet spring pressure and push the 11A-poppet piston nose clear of the 12A-poppet nose receiving orifice. When this happens the 5A-reed/proximity switch which, is secured to the exterior of the 2A-pressure housing, will detect the movement of the magnetic field generated by the 6A-magnet which is mounted on the interior or exterior of the 3A-poppet piston. The alignment of the magnetic field generated by 6A-magnet will cause the electrical contacts within the 5A-reed/proximity switch to open or close. The opening or closing of the 5A-reed/proximity switch electrical contacts will complete an electrical circuit. The “making” or “breaking” of this electrical circuit will be used to indicate that material is flowing through the high pressure flow indicating switch.

The gaseous or liquid material flowing past the 11A-poppet piston nose will travel past or through the first 17A-poppet piston skirt and then through a 13A-hole in the 3A-poppet piston then through the 14A-spring recess where it will then be discharge through the flow indicating switch 16A-outlet.

As the material flowing through the flow indicating switch decreases to, or below, the predetermined volume, the 7A-poppet return piston spring will push the 3A-poppet piston to its normally closed or “no flow” position. The ensuing misalignment of the magnetic field generated by 6A-magnet and the 5A-reed/proximity switch will cause the electrical contacts within the 5A-reed/proximity switch to open or close. The opening or closing of the 5A-reed/proximity switch contacts will complete an electrical circuit. The “making” or “breaking” of this electrical circuit will indicate that “no flow” is present within the flow indicating switch.

If the pressure downstream of the high pressure flow indicating switch becomes greater than that of the upstream pressure, the 8A-O-ring will seat against the 3A-poppet piston and the 1A-cylinder housing cap thus causing the flow indicating switch to convert to a check valve.

NOTE: The 8A-check valve O-ring may be omitted if the check valve function of this switch is not desired.

NOTE: The flow/volume which will activate or deactivate the high pressure flow indicating switch can be increased or decreased by the altering the clearance between the 11A-poppet piston nose and the 12A-poppet nose receiving orifice and/or changing the 7A-poppet piston return spring pressure.

NOTE: An alternate to the manufacturing of this flow indicating switch would be that the 3A-poppet piston and 7A-spring could be reversed and the 12A-poppet nose receiving orifice could be located in the 2A-cylinder pressure housing. If this manufacturing procedure is used the 16A-discharge opening would then become the 15A-inlet.

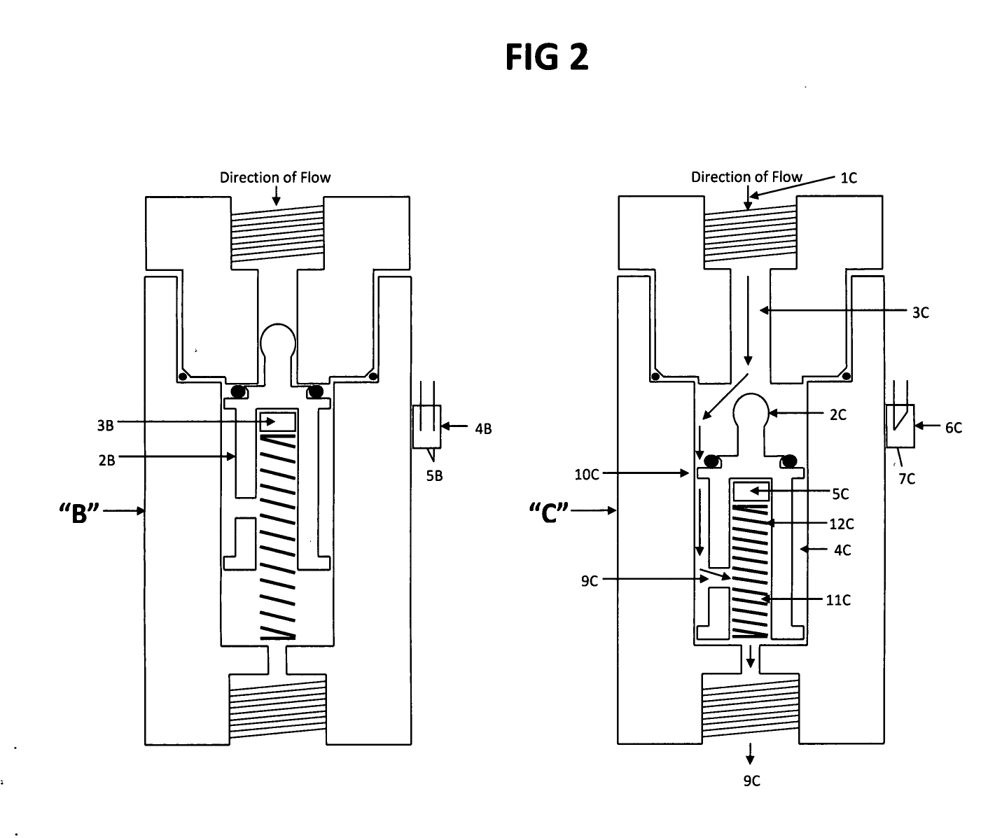

### FIG. 2

The two drawings on this page show a flow indicator switch in a “No Flow” and “Flow” position. While drawing “B” shows the reed/proximity switch in a normally open condition with no flow passing through the flow indicating switch, a normally closed reed/proximity switch could be used for the “no flow” position.

Drawing “B” shows a flow indicating switch which has no flow passing through it. The 2B-poppet piston is seated and in the check valve position so that pressure/material back flow is not possible. The magnet 3B is not aligned with 4B-reed/proximity switch and the 5B-electrical contacts are in the normally open position.

Drawing “C” demonstrates a material (either gaseous, liquid or finely divided solids) flowing through the flow indicating switch. Material flow enters the 1C-inlet will first run into resistance from 2C-poppet nose which is seated in the 3C-poppet nose receiving orifice. As the flow volume increases to a point above the predetermined quantity, which is established by the clearance between the 2C-poppet noses and the 3C-poppet nose receiving orifice and/or 12C-poppet piston return spring tension, the 4C-poppet piston will move in the direction of the material flow. As the 4C-poppet piston nears the end of its travel the 5C-poppet piston magnet will align with the 6C-reed/proximity switch which in turn will close the 6C-reed/proximity switch 7C-contacts to complete the electrical circuit. This electrical signal will be used to indicate that flow through the flow indicating switch is present.

As the 4C-poppet piston nears its maximum travel the material flow will travel past the 2C-poppet piston nose, around or through the 10C-first poppet piston skirt, along the body of the 4C-poppet piston and into the 9C-piston lower orifice. The material will then enter the 11C-poppet piston spring recess and will then discharge through the 8C-discharge opening.

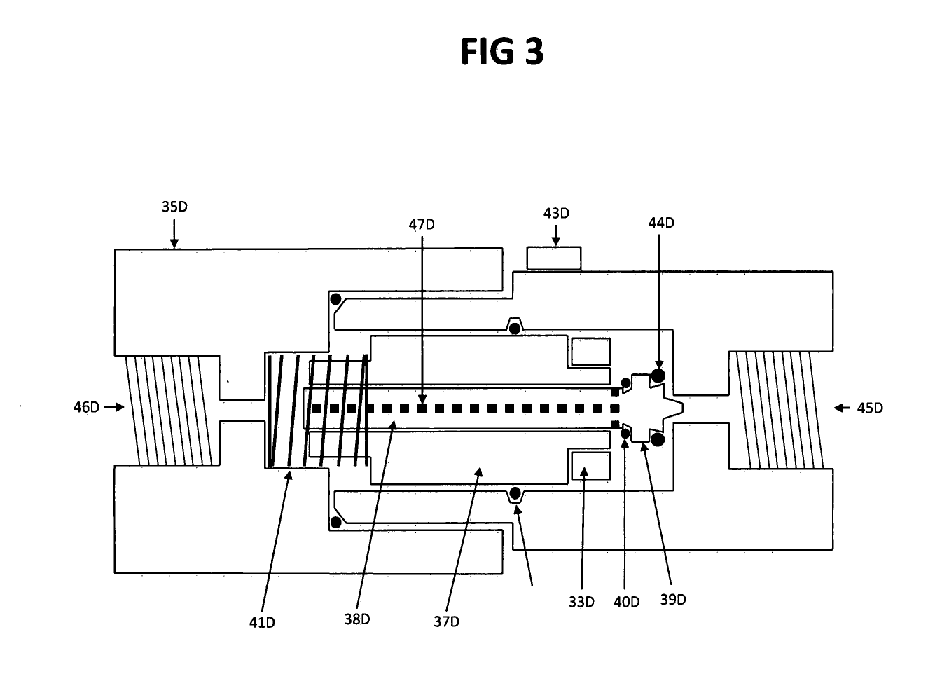

### FIG. 3

A tight seal between the upstream and downstream sides of the high pressure flow indicating switch is accomplished by the 39D-secondary poppet piston head seating against the 40D-O-ring which in turn is seated against the to the 37D-primary poppet piston and the 42D-O-ring which seals the 37D-primary poppet piston the 36D cylinder wall housing.

As the flow pressure of a compressed gas, liquid or finely divided solid material entering the 45D-inlet increases above a predetermined point, which is set by the 41D-primary poppet piston return spring, the 37D-primary poppet piston assembly will move downstream with the flow of the material to the near “open position”. As the piston assembly approaches the near “open” position, the bottom of the 38D-secondary poppet piston strikes the 35D-housing cap. As the piston assembly reaches the “fully open” position, the 39D-secondary poppet piston head and 40D-O-ring are forced away from the 37D-primary piston thus allowing material to flow through the 47D-secondary poppet piston internal material passage and exiting through the 46D-outlet.

When the 37D-primary poppet assembly nears its “fully open” position the magnetic field of the 33D-magnet, which is attached to and moves with the 37D-primary poppet piston assembly, aligns with the 43D-reed/proximity switch thus opening or closing the reed/proximity switch electrical contacts. The opening or closing of the 43D-reed/proximity switch contacts will complete an electrical circuit. The “making” or “breaking” of this electrical circuit will indicate that “flow” is present within the flow indicating switch.

As the material flow through the high pressure flow indicating switch slows or stops completely the 41D-primary poppet piston return spring moves the piston, magnet and its magnetic field to the “closed” position, which in turn will open or close the 43E-reed/proximity switch electrical contacts. The electrical signal from the 43E-reed/proximity switch will indicate that the piston assembly is in the “closed” position and that “no flow” is presently passing through the high pressure flow indicating switch.

As the differential pressure/flow downstream of the flow indicating switch increases to a point where it is greater than the upstream pressure, the increasing pressure assists the 41D-spring and forces the 37D-primary piston upstream which causes the 37D-primary poppet piston to seat to the 40D-O-ring between it that the 39D-secondary poppet piston head. At the same time the 39D-secondary poppet piston head will seat against the 44D-O-ring and the 36D-Cylinder wall housing thus converting the flow indicating switch into a check valve.

NOTE: The 44D-check valve O-ring may be omitted if the check valve function of this switch is not desired.

NOTE: Flow volume/pressure required to open the high pressure flow indicating switch can be adjusted by adjusting the 41D-piston spring pressure.

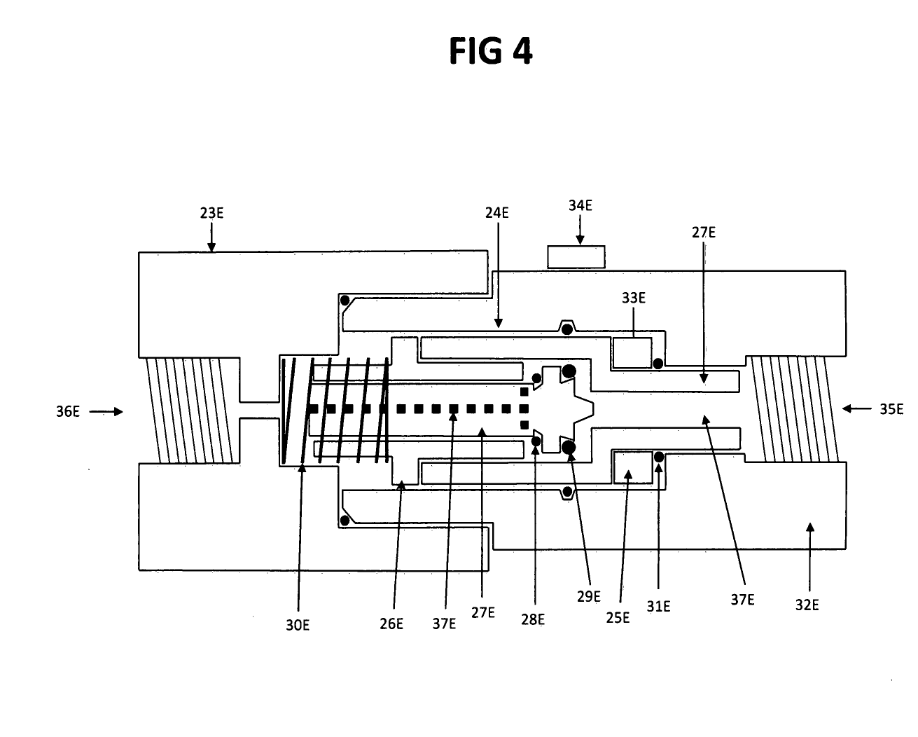

### FIG. 4

A tight seal between the upstream and downstream sides of the flow indicating switch is accomplished by the 24E-O-ring sealing the 32E-cylinder wall housing to the 25E-upper primary poppet piston and the flow/differential pressure forcing the 27E-secondary poppet piston down which will cause the 28E-poppet piston o-ring to make a seal against the 26E-lower primary poppet piston internal shoulder.

As the flow of a material (either compressed gas, liquid or finely divided solid) entering the 35E-inlet, increases above a predetermined point, which is set by the 30E-primary poppet piston return spring, the 25E-primary poppet piston assembly will move downstream with the flow of the material to the near “open position”. As the piston assembly approaches the near “open” position, the bottom of the bottom of the 27E-secondary poppet piston strikes the 23E-housing cap. As the piston assembly reaches the “fully open” position, the 27E-secondary poppet piston head and 28E-O-ring are forced away from the 26E-lower primary piston thus allowing material to flow through the 37E-poppet piston nose orifice, into and through the 37E-secondary poppet piston internal passage and exit through the 36E-outlet.

As the 25E-primary poppet assembly nears its “fully open” position, the magnetic field of the 33E-magnet, which is attached to and moves with the 25E-primary poppet piston assembly, aligns with the 34E-reed/proximity switch, the 34E-reed/proximity switch contacts will either open or close. The opening or closing of the 34-reed/proximity switch contacts will “make” or “break” an electrical circuit. The “making” or “breaking” of this electrical circuit will indicate that “flow” is present within the flow indicating switch.

As the material flow through the high pressure flow indicating switch slows or stops completely the 30E-primary poppet piston return spring moves the piston, magnet and its magnetic field to the “closed” position, which in turn will open or close the 34E-reed/proximity switch electrical contacts. The electrical signal from the 34E-reed/proximity switch will indicate that the piston assembly is in the “closed” position and that “no flow” is presently passing through the high pressure flow indicating switch.

As the differential pressure/flow downstream of the flow indicating switch increases to a point where it is greater than the upstream pressure, the increasing pressure assists the 30E-spring and forces the 25E-primary piston assemble toward the upstream flow which causes the 25E-primary poppet piston to seat the 31E-O-ring between it and the 32E-cylinder wall housing. At the same time the 27E-secondary poppet piston head will seat against the 29E-O-ring to the top of the 25E-primary poppet piston interior thus converting the flow indicating switch into a check valve.

NOTE: Flow volume/pressure required to open the high pressure flow indicating switch can be adjusted by changing the 30E-piston spring pressure.

NOTE: The 29E-check valve O-ring and the 29E-O-ring may be omitted if the check valve function of this switch is not desired.

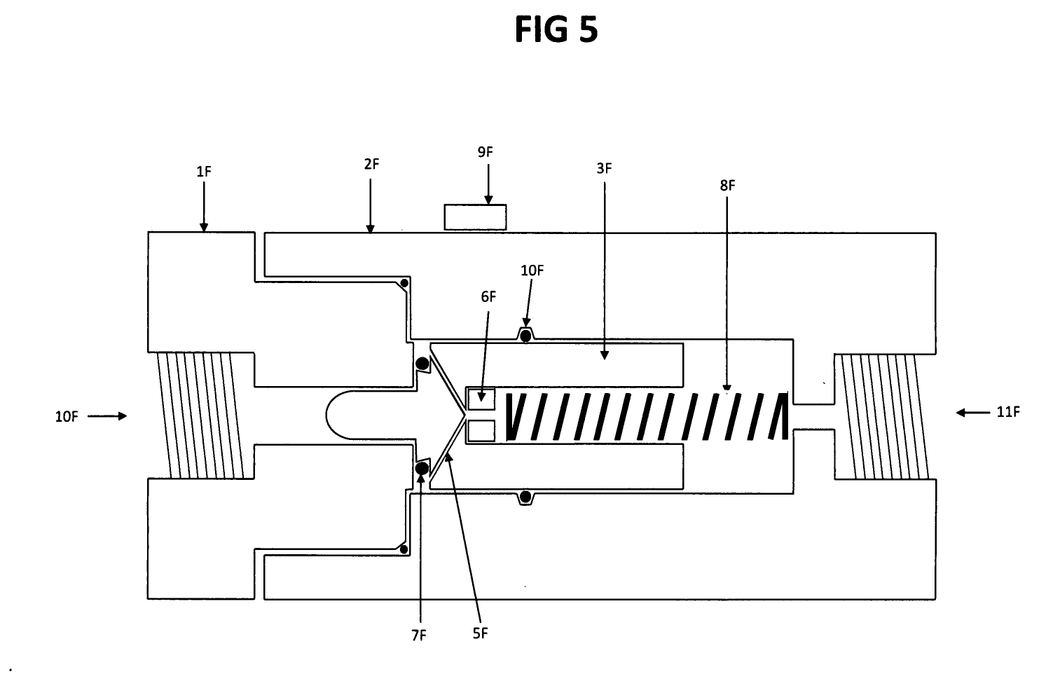

### FIG. 5

As the material (either compressed gas, liquid or finely divided solid) entering the 10E-inlet and flowing through the high pressure flow indicting switch exceed a predetermined quantity, which is set by the 8F-poppet piston return spring and the 5F-poppet piston bypass orifices, a pressure/flow buildup will occur in the 2F-cylinder between the 1F-cylinder cap and the 3F-poppet piston. When the pressure/flow buildup is sufficient to exceed the flow handling capabilities of the 5F-poppet piston bypass orifices and overcome the 8F-poppet piston return spring, the 3F-poppet piston will move downstream in the direction of the flow of the material to its near “open position”.

As the 3F-primary poppet assembly nears its “fully open” position, the magnetic field of the 6F-magnet, which is attached to and moves with the 3F-poppet piston, aligns with the 9F-reed/proximity switch, the 9F-reed/proximity switch electrical contacts will either open or close. The opening or closing of the 9F-reed/proximity switch contacts will complete an electrical circuit. The “making” or “breaking” of this electrical circuit will indicate that “flow” is present within the flow indicating switch.

As the 3F-poppet piston reaches the “fully open” position, the increase of differential pressure between the upstream and downstream sides of the 3F-poppet piston, the flowing material will be forced through the 5F-poppet piston bypass orifices allowing material to flow exit through the 11F-outlet.

As the differential pressure downstream begins to equalize with upstream pressure, the 8F-poppet piston return spring will move the 3F-poppet piston to the “closed” position. As the 3F-poppet piston & 6F-magnet moves to the “closed” position the magnetic field generated by the 6F-magnet will move and open or close the 9F-reed/proximity switch electrical contacts. The opening or closing of the 9F-reed/proximity switch contacts will complete an electrical circuit. The “making” or “breaking” of this electrical circuit will indicate that “no flow” is present within the flow indicating switch.

As the differential pressure downstream of the flow switch increases to a point where it is greater than the upstream pressure, the 7F-check valve o-ring seats against the cap thus converting the flow indicating switch into a check valve.

NOTE: A predetermined amount of material flow through a “closed” high pressure flow indicating switch will be present at all times.

NOTE: The amount of material flow through the switch while in the “closed” position or to “open” the high pressure flow indicating switch can be adjusted by changing the 5F-poppet piston bypass orifices and/or changing the spring tension of the 8F-poppet return spring.

NOTE: The 7F-check valve O-ring may be omitted if the check valve function of this switch is not desired.

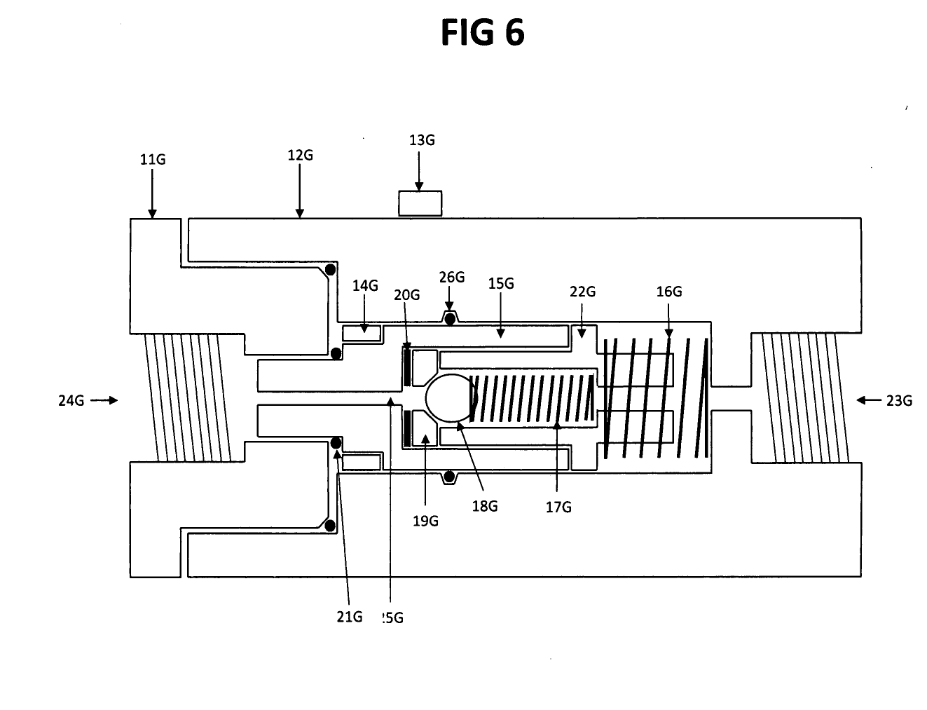

### FIG. 6

FIG. 6 demonstrates the high pressure flow indicating switch which has been configured to also function as a back pressure regulator/holding valve. The check ball assembly, consisting of the 18G-check ball, 20G-check ball seat O-ring, 19G-check ball seat and 17G-check ball spring, is held in place between the 15G-upper poppet piston housing and the 22G-lower poppet piston. In the closed position, a tight seal between the upstream and downstream sides of the flow indicating switch is accomplished by the 26G-O-ring sealing the 12G-cylinder wall housing to the 15G-upper primary poppet piston and the 17G-checkball spring which seating the 18G-checkball to the 19G-checkball seat.

As the flow of a material (either compressed gas, liquid or finely divided solid) entering the 23G-inlet, increases above a predetermined point, which is set by the 16G-primary poppet piston return spring and the 17G-checkball spring pressure, the 15G-primary poppet piston assembly will move downstream with the flow of the material to the near “open position”.

As the 15G-primary poppet assembly nears its “fully open” position, the magnetic field of the 14G-magnet, which is attached to and moves with the 15G-primary poppet piston assembly, aligns with the 13G-reed/proximity switch opening or closing the 13G-reed/proximity switch electrical contacts. The opening or closing of the 13G-reed/proximity switch electrical contacts will “make” or “break” an electrical circuit. The “making” or “breaking” of this electrical circuit will indicate that “flow” is present within the flow indicating switch.

Once the upstream to downstream pressure differential is sufficient to overcome the 17G-check ball spring tension, material will flow into 25G-poppet piston nose orifice, pushing past the 18G-check ball and then exiting the high pressure flow indicating switch through the 24G-outlet.

As the differential pressure downstream begins to equalize with upstream pressure, the 17G-check ball return spring will move the 18G-check ball to the “closed” position. As the pressure differential reaches near equalization, pressure applied by the 16G-primary poppet piston return spring will move the 15F-primary poppet piston assembly to the “closed” position.

As the 15G-primary poppet assembly nears its “closed” position, the magnetic field of the 14G-magnet, which is attached to and moves with the 15G-primary poppet piston assembly, misaligns with the 13G-reed/proximity switch, the 13G-reed/proximity switch electrical contacts will either open or close. The opening or closing of the 13G-reed/proximity switch electrical contacts will “make” or “break” an electrical circuit. The “making” or “breaking” of this electrical circuit will indicate that “no flow” is present within the flow indicating switch.

If the differential pressure downstream of the flow indicating switch increases to a point where it is greater than the upstream pressure, the 21G-check valve o-ring is forced to seat against the 12G-cylinder pressure housing and the 17G-checkball spring seats the 18G-checkball to the 19G-checkball seat thus converting the flow indicating switch into a check valve.

NOTE: The pressure at which the high pressure flow indicating switch will indicate flow can be adjusted by changing the 16G spring pressure. The holding pressure, at which the high pressure flow indicating switch will allow material to pass through, and still maintain the minimal upstream material pressure, can be adjusted by changing the 17G-checkball spring pressure.

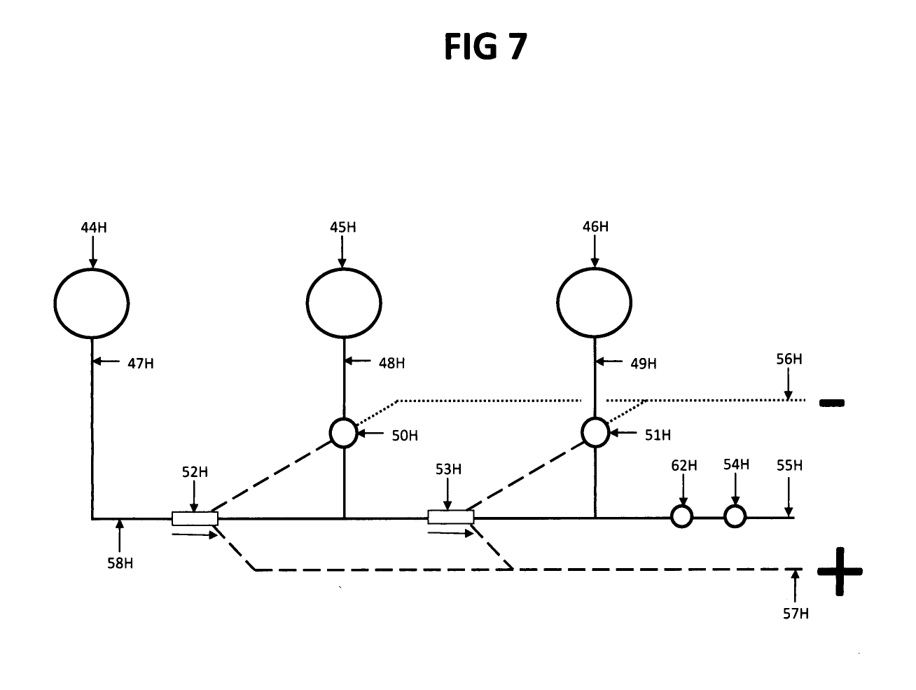

### FIG. 7

This figure demonstrates a 3-stage auto-cascade system which uses the High Pressure Flow Indicating Switch as the key component used to accurately control the sequential discharge of compressed gas storage cylinders into a cylinder which is being recharged.

Basic gas flow mapping: The flow from the 44H-low pressure storage cylinder will flow through the 52H and 53-high pressure flow indicating switches. The flow from the 45H-medium pressure storage cylinder will pass through the second stage 50H-electric over pneumatic solenoid valve and then flow through the 53H-high pressure flow indicating switch. And the flow from the 46H-high pressure storage cylinder will flow directly to the 62H-pressure reducing regulator.

The pressure from the three storage cylinders will flow through the 62H-pressure regulator which will reduce the incoming compressed air/gas pressure to the correct pressure which is required by the SCBA cylinder being recharged. The reduced air/gas pressure then flows downstream where its flow is stopped by the 54H-bock valve.

Actual operational results: A 55-SCBA/SCUBA cylinder is connected downstream of the “closed” 54H-block valve which is located just downstream of the 62-pressure reducing regulator. Since the 54H-block valve is closed, no compressed air/gas will be flowing through the 52H or 53H-flow indicating switch thus their respective 50H and 51H-electric over pneumatic solenoid valves will remain in their “normally open” position allowing pressure/flow from the 44H, 45H and 46H-storage cylinders to move downstream through their respective 47H, 48H, 49H-tubing. The 44H-low pressure storage cylinder shall be connected directly to the 58H-tubing. The 45H-medium pressure storage cylinder will be connected to the 50H-second stage solenoid valve and the 46-high pressure storage cylinder will be connected to the 51H-third stage solenoid valve.

When the 54H-block valve is opened compressed air/gas from the 44H-low pressure storage cylinder will flow downstream through the 58-tubing. As the compressed air/gas flows downstream through the 58-tubing it will pass through the 52H-second stage flow indicating switch which will initiate and send an electric current which will close the 50H-second stage solenoid valve which will prevent downstream flow from the 45H-medium pressure storage cylinder. The compressed air/gas will then flow through the 53H-third stage flow indicating switch which will initiate and send an electric current which will close the 51H-third stage solenoid valve which will prevent flow from the 46H-high pressure storage cylinder. In this way only compressed air/gas from the 44H-low pressure storage cylinder is permitted to flow into the 55H-SCBA cylinder being recharged.

As the pressures between the 44H-low pressure storage cylinder and the 55H-SCBA being recharged begin to equalize, the flow of compressed air/gas passing through the 52H and 53H-flow indicating switches will slow or stop. The stoppage of flow through the 52H-second stage and 53H-third stage high pressure flow indicating switches will cause the electric current going to their respective 50H-second stage solenoid valves and 51H-third stage solenoid valves to be stopped thus enabling these two solenoid valves to revert to their normally open position.

The opening of the second stage 50H and third stage 51H-electric over pneumatic solenoid valve re-establishes the compressed air/gas flow through the 58-tubing. Since the pressure downstream of the 52H-second stage flow indicating switch is greater than the upstream pressure, the 52H-second stage flow indicating switch will convert to its secondary function as a check valve thus preventing pressure/flow from moving upstream from the 45H-medium pressure storage cylinder into the 44H-low pressure storage cylinder. This upstream to downstream pressure differential also aids in holding the 52H-flow indicating switch in the “close” position which in turn will keep the second stage 50H-electric over pneumatic solenoid valve in the “open” position.

At the same time that the pressure/flow is being restricted from flowing upstream of 52H-second stage flow indicating switch, the downstream pressure/flow begin pass through the 58H-tubing and as it pass through the 53H-third stage flow indicating switch will cause electrical current to be sent to the 51H-third stage electric over pneumatic solenoid valve causing it to close thus permitting pressure/gas from only the 45H-medium pressure storage cylinder entering the 58-tubing and then subsequently flowing into the 55H-SCBA cylinder being recharged.

As the pressures near equalization between the 45H-medium pressure storage cylinder and the 55H-SCBA cylinder being recharging, the flow of air/gas will slow or stop. The stoppage of flow through the 53H-third stage high pressure flow indicating switches will cause the electric current going to 51H-third stage solenoid valves to be stopped thus enabling the 51H-third stage solenoid valve to revert to its normally open position.

The opening of the third stage 51H-electric over pneumatic solenoid valve re-establishes the compressed air/gas flow through the 58-tubing. Since the pressure downstream of the 52H-second stage flow indicating switch and the 53H-third stage flow indicating switch is greater than the upstream pressure, the 52H-second stage flow indicating switch and the 53H-third stage flow indicating switches converts to their secondary function as a check valve thus preventing pressure/flow from moving upstream into the 44H-low pressure storage cylinder and the 45H-medium pressure storage cylinders thus permitting pressure/gas from only the 46H-high pressure storage cylinder entering the 58-tubing and then subsequently flowing into the 55H-SCBA cylinder being recharged.

Note: While this demonstrates a 3-stage system, in actuality, this auto-cascade configuration can incorporate an infinite number of stages. Also, while this figure demonstrates the auto-cascade recharging a SCBA/SCUBA cylinder with compressed breathing air CGA grade “D”, “E”, and/or “L”, the auto-cascade in this design can be used with any type of compressed gas.

I claim:

1- A device which is pneumatic or hydraulic actuated flow indicator switch capable of operating at pressures greater than 1100 psi which is comprised of:
a. Pressure housing, which is constructed of a material which will allow the passage of a magnetic field with minimal distortion, with internal bore for the poppet piston to travel in and an inlet or outlet opening.
b. Pressure cylinder housing cap with an inlet or outlet opening.
c. Poppet piston assembly.
d. Poppet piston return spring.
e. Magnetic source attached to, and traveling with, the poppet piston.
f. Magnetically actuated reed/proximity switch which is attached externally on the primary cylinder housing which will sense the position (open or closed) of the poppet piston assembly magnetic source.
g. O-ring and mounting surface which may be machined into or attached to the poppet piston which allows the high pressure flow indicating switch to convert to a check valve (if required for specific application) if the downstream pressure/flow becomes greater than that of the upstream pressure.
h. Poppet piston assembly which will allow gas, liquid or finely divided solid entering the inlet, to pass through or around the assembly, and then exit the pressure housing once the poppet piston is in the open or near open position.

2- A device as indicated in claim 1 which converts to a reverse flow check valve in the event of downstream pressure increasing to a point equal to or greater than upstream pressure.

3- A device as indicated in claim 1 which does not have to be converted to a reverse flow check valve in the event of downstream pressure increasing to a point equal to or greater than upstream pressure.

4- A device as indicated in claim 1 which can be used as a back pressure regulator or to hold a minimal specific pressure on the upstream side of the flow indicating switch.

5- A devise as indicated in claim 1 which will automatically control the discharge sequence of one or more compressed gas storage cylinder(s) which is used to recharge SCBA/SCUBA cylinder(s) via electrical, electric over pneumatic or electric over hydraulic solenoid valve(s).

6- A devise as indicated in claim 1, which can be used in conjunction with a computer, micro processor or circuit board, which will automatically control the discharge sequence of one or more compressed gas storage cylinder(s) which is used to recharge SCBA/SCUBA cylinder(s) via electrical, electric over pneumatic or electric over hydraulic solenoid valve(s).

7- A devise as indicated in claim 1, which is not required to be used in conjunction with a computer, micro processor or circuit board, which will automatically control the discharge sequence of one or more compressed gas storage cylinder(s) which is used to recharge SCBA/SCUBA cylinder(s) via electrical, electric over pneumatic or electric over hydraulic solenoid valve(s)

8- A devise as indicated in claim 1 which will automatically control the discharge sequence of one or more compressed gas storage cylinder(s) which is used to recharge any type of compressed gas cylinder(s) via electrical, electric over pneumatic or electric over hydraulic solenoid valve (s).

9- A devise as indicated in claim 1, which can be used in conjunction with a computer, micro processor or circuit board, which will automatically control the discharge sequence of one or more compressed gas storage cylinder(s) which is used to recharge any type of compressed gas cylinder(s) via electrical, electric over pneumatic or electric over hydraulic solenoid valve(s).

10- A devise as indicated in claim 1, which is not required to be used in conjunction with a computer, micro processor or circuit board, which will automatically control the discharge sequence of one or more compressed gas storage cylinder(s) which is used to recharge any type of compressed gas cylinder(s) via electrical, electric over pneumatic or electric over hydraulic solenoid valve(s).

11- A devise as indicated in claim 1 which will accurately, over a wide range of pressures, indicate the flow of a gaseous, liquid or finely divided solid material through a pipe, tube or equipment.

12- A devise comprised of items listed in claim 1 which will automatically control the discharge sequence of one or more compressed gas storage cylinder(s) which is used to recharge any type of compressed gas cylinder(s) via electrical, electric over pneumatic or electric over hydraulic solenoid valve(s) thus creating an automatic cascade recharging system used for the filling of Fire Fighter SCBA or Diving SCUBA cylinder(s).

13- A devise which will allow an auto-cascade system as indicated in claim 12 to be retro-fitted into an existing manual cascade panel.

14- A devise which will allow an auto-cascade system as indicated in claim 12 to be retro-fitted into an existing pneumatically controlled auto-cascade panel.

15- A devise which will allow an auto-cascade system as indicated in claim 12 to be attached to a high rise buildings fire fighting SCBA recharging standpipe system and function correctly and efficiently when SCBA cylinders are being recharged from remote standpipe fill locations.

16- A method of determining pneumatic or hydraulic flow through a line, tube or equipment which is comprised of:
a. Pressure housing, which is constructed of a material which will allow the passage of a magnetic field with minimal distortion, with internal bore for the poppet piston to travel in and an inlet or outlet opening.
b. Pressure cylinder housing cap with an inlet or outlet opening.
c. Poppet piston assembly.
d. Poppet piston returns spring.
e. Magnetic source attached to, and traveling with, the poppet piston.
f. Magnetically actuated reed/proximity switch which is attached externally on the primary cylinder housing which will sense the position (open or closed) of the poppet piston assembly magnetic source.
g. O-ring and mounting surface which may be machined into or attached to the poppet piston which allows the high pressure flow indicating switch to convert to a check valve (if required for specific application) if the downstream pressure/flow becomes greater than that of the upstream pressure.
h. Poppet piston assembly which will allow to gas, liquid or finely divided solid entering the inlet, to pass through or around the poppet piston assembly, and then exit the pressure housing once the poppet piston is in the open or near open position.

17- A method of a high pressure flow indicating switch consisting of items mentioned in claim 16, which determines flow through a pipe or tube by use of a magnetic source which is attached to and moves with the spring loaded poppet piston which travels with the material flow within a pressure cylinder housing through which a magnetic field can pass with minimal distortion, which activates and/or deactivates an externally mounted reed/proximity switch.

18- A method of compressed gas cylinder recharging by which the items listed in claim 16 which will indicate flow or no flow conditions through a pipe or tube thus opening or closing electric, electric over pneumatic and/or electric over hydraulic solenoid valves which are attached to high pressure storage cylinders, and which will be the basis of an auto-cascade system used for recharging compressed gas cylinder(s).

19- A method comprised of items listed in claim 16 which will automatically control the discharge sequence of one or more compressed gas storage cylinder(s) which is used to recharge any type of compressed gas cylinder(s) via electrical, electric over pneumatic or electric over hydraulic solenoid valve(s) thus creating an automatic cascade recharging system used for the filling of Fire Fighter SCBA or Diving SCUBA cylinder(s).

20- A method which will allow an auto-cascade system as indicated in claim 18 to be attached to a high rise buildings fire fighting SCBA recharging standpipe system and function correctly and efficiently when SCBA cylinders are being recharged from remote standpipe fill locations.
